(19) United States
(12) Patent Application Publication
(10) Pub. No.: US 2004/0223190 A1
(43) Pub. Date: Nov. 11, 2004

(54) Image generating method utilizing on-the-spot photograph and shape data

(76) Inventor: Masaaki Oka, Kanagawa (JP)

Correspondence Address: William S. Frommer, Esq., FROMMER LAWRENCE & HAUG LLP, 745 Fifth Avenue, New York, NY, 10151, US

(21) Appl. No.: 10/780,303

(22) Filed: Feb. 17, 2004

(30) Foreign Application Priority Data
Feb. 17, 2003 (JP) 2003-38645

(51) Int. Cl. H04N 1/21; H04N 1/40

(52) U.S. Cl. 358/302

(57) ABSTRACT

There are provided a technique for generating a three-dimensional image of the real world. The image generating system comprises a data management apparatus which stores three-dimensional shape data of at least a part of an object area; a camera which shoots at least a part of the object area; an image generating apparatus which generates an image of the object area using the three-dimensional shape data acquired from the data management apparatus and the picture shot by the camera.

### BACKGROUND OF THE INVENTION

1. Field of the Invention

The present invention relates to an image generating technology, and more particularly to an image generating system, an image generating apparatus, and an image generating method for generating an image of an object area utilizing an on-the-spot photograph and shape data.

2. Description of the Related Art

In recent years, a user is provided not only with a two-dimensional still image or an animation but with a three-dimensional virtual reality world. Attractive contents with presence, such as a walk-through picture inside a building inserted on a web page which introduces the building, came to be provided.

Such a three-dimensional virtual reality world is usually built by carrying out a modeling of a shape of the three-dimensional space in the real world or the virtual world beforehand. A contents providing apparatus stores modeling data built in a storage. When a viewpoint and a view direction are specified by a user, the contents providing apparatus renders the modeling data and provide a rendered image to the user. The contents providing apparatus carries out a re-rendering of the modeling data whenever the user changes the viewpoint or the view direction, and shows the generated image to the user. A user can be provided with an environment to move freely in the three-dimensional virtual reality world, and acquire an image thereof.

However, in the above-mentioned example, since the three-dimensional virtual reality world is built with the shape data modeled beforehand, the present state in the real world is unreproducible in real time.

### SUMMARY OF THE INVENTION

In view of the above circumstances, an objective of the present invention is to provide a technique for generating a three-dimensional image of the real world. Another objective of the present invention is to provide a technology for reproducing the present condition in the real world in real time.

An aspect of the present invention relates to an image generating system. This image generating system comprises: a database which stores a first shape data which represents a three dimensional shape of a first area including at least a part of an object area; a camera which shoots a second area including at least a part of the object area; and an image generating apparatus which generates an image of the object area by means of a picture shot by the camera and the first shape data, wherein said image generating apparatus includes: a data acquiring unit which acquires the first shape data from said database; a picture acquiring unit which acquires the picture from said camera; a first generating unit which generates an image of the first area by setting a predetermined viewpoint and a view direction and rendering the first shape data; a second generating unit which generates an image of the second area when seeing from the viewpoint toward the view direction by using the picture; and a compositing unit which composites the image of the first area with the image of the second area to generate the image of the object area.

The image generating apparatus may further comprise a calculating unit which calculates a second shape data which represents a three dimensional shape of the second area by means of a plurality of the pictures acquired from said plurality of cameras; and said second generating unit may set the viewpoint and the view direction and render the second shape data to generate the image of the second area. The compositing unit may generate the image of the object area by complementing an area that is not represented by the second shape data with the image of the first area generated from the first shape data.

The database may store a first color data which represents a color of the first area; and the image generating apparatus may further include a lighting calculating unit which calculates a situation of a lighting in the picture shot by comparing the first color data acquired from said database with a color data of the picture shot. The first generating unit may add an effect of a lighting similar to the lighting in the picture shot to the image of the first area in consideration of the situation of the lighting. The first generating unit may add predetermined effect of a lighting to the image of the first area; and the second generating unit may add the predetermined effect of the lighting to the image of the second area, after once removing the effect of the lighting from the image of the second area.

The image generating system may further comprise a recording apparatus which stores the picture shot; said database may store a plurality of the first shape data corresponding to the object areas of a plurality of time; and said image generating apparatus may further include: a first selecting unit which selects the first shape data to be acquired by the data acquiring unit among the plurality of the first shape data stored in said database; and a second selecting unit which selects the picture shot to be acquired by the picture acquiring unit among the pictures stored in said recording apparatus.

Moreover, this summary of the invention does not necessarily describe all necessary features so that the invention may also be implemented as sub-combinations of these described features or other features as described below.

### BRIEF DESCRIPTION OF THE DRAWINGS

FIG. 1 shows a structure of an image generating system according to a first embodiment of the present invention.

FIG. 2 schematically shows a process of an image generating method according to the first embodiment.

FIG. 3 shows an internal structure of an image generating apparatus according to the first embodiment.

FIG. 4 shows an internal structure of a data management apparatus according to the first embodiment.

FIG. 5 shows an internal data of a three-dimensional shape database.

FIG. 6 shows an actual state of the object area.

FIG. 7 shows an image of a first area generated by the modeling data registered into the data management apparatus.

FIG. 8 shows the pictures of the second area shot by the camera.

FIG. 9 shows the pictures of the second area shot by the camera.

FIG. 10 shows the pictures of the second area shot by the camera.

FIG. 11 shows an image of a second area generated based on the real shape data calculated from the picture shot.

FIG. 12 shows an image generated by compositing the image of the first area shown in FIG. 7 and the image of the second area shown in FIG. 11.

FIG. 13 illustrates computing a situation of lighting.

FIG. 14 illustrates another method for calculating the situation of lighting.

FIG. 15 shows an approximated formula of a Fog value.

FIG. 16 shows how to obtain the value “a” in the approximated formula of a Fog value, which is an intersection point of two exponential functions.

FIG. 17 is a flowchart showing the procedure of the image generating method according to the first embodiment.

FIG. 18 is a flowchart showing the procedure of the lighting calculating method according to the first embodiment.

FIG. 19 shows a structure of an image generating system according to a second embodiment of the present invention.

FIG. 20 shows an internal structure of the image generating apparatus according to the second embodiment.

FIG. 21 shows an internal data of the management table according to the second embodiment.

FIG. 22 shows an example of the selecting screen showed by the interface unit of the image generating apparatus.

FIG. 23 shows a screen showing the image of the object area generated by the image generating apparatus.

### DETAILED DESCRIPTION OF THE INVENTION

The invention will now be described based on preferred embodiments which do not intend to limit the scope of the present invention but exemplify the invention. The features and the combinations thereof described in the embodiments are not necessarily all essential to every implementation of the invention.

(First Embodiment)

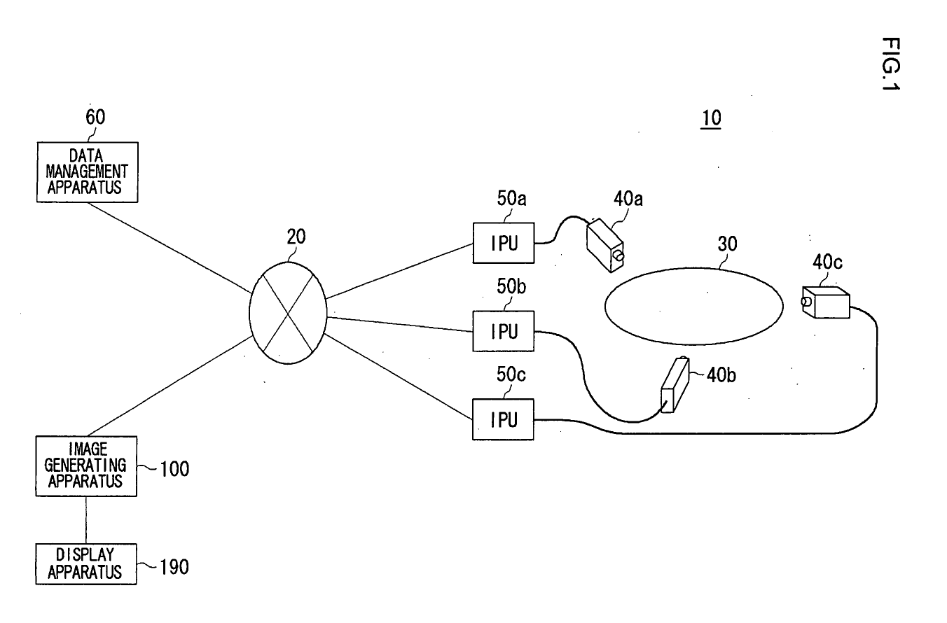

FIG. 1 shows a structure of an image generating system 10 according to a first embodiment of the present invention. In order to generate and display an image of an object area 30 viewed from a predetermined viewpoint toward a predetermined view direction in real time, an image generating system 10 according to the present embodiment acquires an on-the-spot photo picture of the object area 30 shot by a camera 40, and a three-dimensional shape data of the object area 30 stored in a data management apparatus 60, and builds a three-dimensional virtual reality world of the object area 30 using them. The object area 30 may be an arbitrary area regardless of an outside or an inside of a room, such as a shopping quarter, a store, and a stadium. For example, the image generating system 10 may be used in order to distribute a present state of the shopping quarter or the store or to carry out on-the-spot relay of a baseball game etc. The three-dimensional shape data, which is generated by modeling an object which does not change or scarcely changes in a short term such as equipment of a stadium and appearance of a building, is registered with the data management apparatus 60. The image generated by rendering the three-dimensional shape data and the image generated by the on-the-spot picture shot in real time by the camera 40 are composited. The state of the object area 30 is unreproducible in real time with only the three-dimensional shape data which is generated by modeling beforehand. Moreover, an area which was a dead angle and was not shot by the camera is also unreproducible with only the on-the-spot picture. On the other hand, it takes huge costs to install many cameras in order to reduce a dead angle. The image generating system 10 can reduce the unreproducible area and generate an image with high accuracy in real time by using both of the shape data and the on-the-spot picture to complement each other.

In the image generating system 10, IPUs (Image Processing Unit) 50a, 50b, and 50c, a data management apparatus 60, and an image generating apparatus 100 are connected each other by an Internet 20 as an example of a network. The IPUs 50a, 50b, and 50c are connected to cameras 40a, 40b, and 40c, respectively, which shoot at least a part of the object area 30. The IPUs 50a, 50b, and 50c processes the picture shot by the cameras 40a, 40b, and 40c, and sends out to the Internet 20. The data management apparatus 60 as an example of a database holding a first shape data (also referred to as “modeling data” hereinafter) which represents the three-dimensional shape of at least a part of the object area 30. The image generated by the image generating apparatus 100 is displayed on a display apparatus 190.

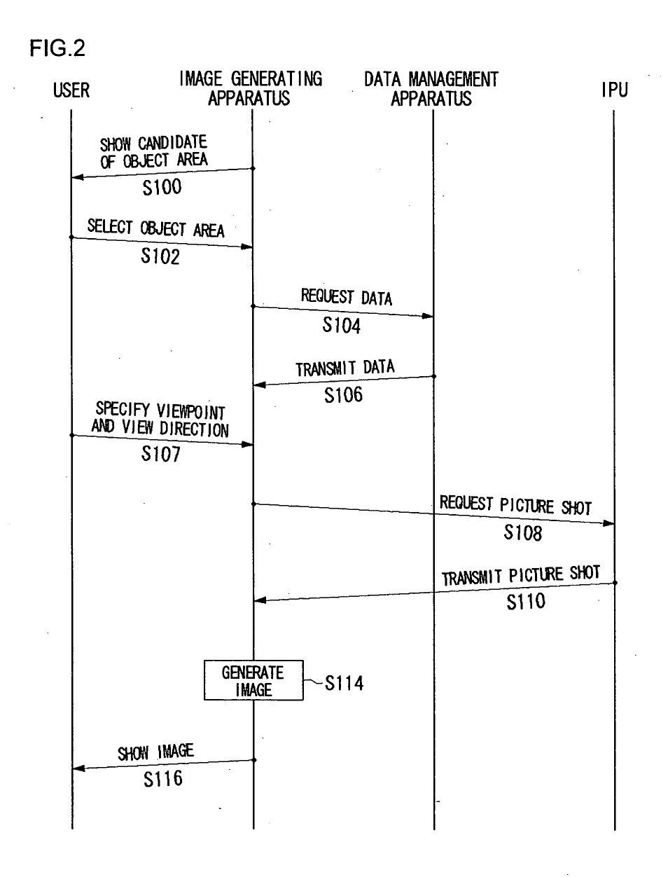

FIG. 2 describes a series of processings in the image generating system 10 by the exchange between a user, the image generating apparatus 100, the data management apparatus 60, and the IPU50. An outline of the processings is explained here, and details will be explained later. First, the image generating apparatus 100 shows a candidate of the object area 30 to the user in which the equipment such as the camera 40 and the IPU 50 and the modeling data are prepared, and whose image can be generated (S100). The user chooses a desired area out of the candidate of the object area showed by the image generating apparatus 100, and directs it to the image generating apparatus 100 (S102). The image generating apparatus 100 requests the data management apparatus 60 to transmit a data concerning to the object area 30 chosen by the user (S104). The data management apparatus 60 transmits the information (for example, an identification number or an IP address) for identifying the camera 40 shooting the object area 30 or the IPU50, the modeling data of the object area 30, and so on to the image generating apparatus 100 (S106). The user directs a viewpoint and a view direction to the image generating apparatus (S106). The image generating apparatus 100 requests the camera 40 or the IPU 50 to transmit the picture shot by the camera 40 (S108). The camera 40 or the IPU 50 requested transmits the picture shot to the image generating apparatus 100 (S110). The shot picture is continuously sent to the image generating apparatus 100 at the predetermined intervals. The image generating apparatus 100 sets the viewpoint and the view direction which is directed by the user, builds the three-dimensional virtual reality world of the object area 30 using the modeling data and the shot picture, and generates the image of the object area 30 when seeing from the directed view point toward the directed view direction (S114). The image generating apparatus 100 may update the image when receiving a change demand of the viewpoint or the view direction from the user, so that the can move freely and look around the inside in the three-dimensional virtual reality world of the object area 30. In the case where a position or a shooting direction of the camera 40 is variable, the image generating apparatus 100 may direct the camera 40 to change the position or the shooting direction in accordance with the viewpoint or the view direction directed by the user. The image generated is showed to the user by the display apparatus 190 (S116).

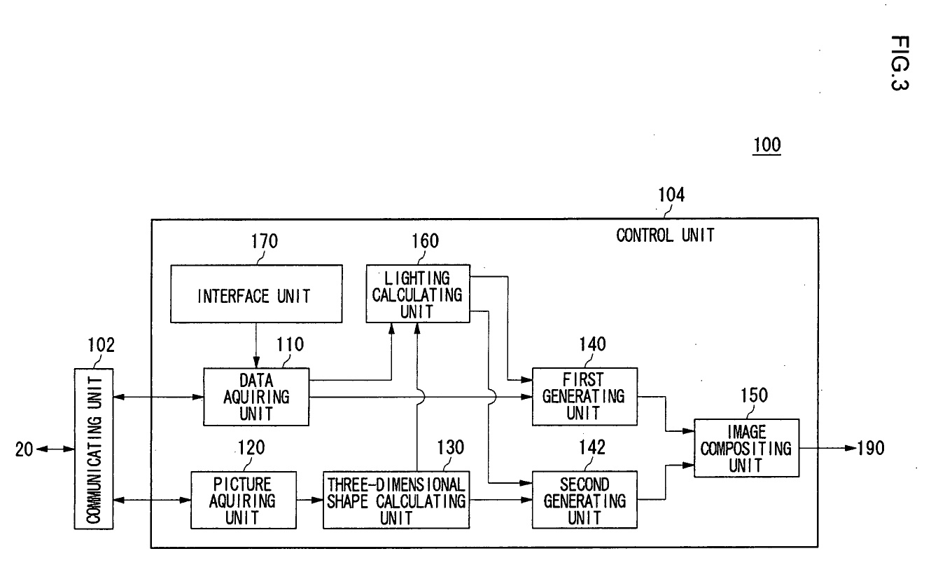

FIG. 3 shows an internal structure of the image generating apparatus 100. In terms of hardware, this structure can be realized by a CPU, a memory and other LSIs of an arbitrary computer. In terms of software, it is realized by memory-loaded programs or the like having a function of generating an image, but drawn and described here are functional blocks that are realized in cooperation with those. Thus, it is understood by the skilled in the art that these functional blocks can be realized in a variety of forms by hardware only, software only or the combination thereof. The image generating apparatus 100 mainly comprises a control unit 104 for controlling an image generating function and a communicating unit 102 for controlling a communication between the control unit 104 and exterior via the Internet 20. The control unit 104 comprises a data acquiring unit 110, an image acquiring unit 120, a three-dimensional shape calculating unit 130, a first generating unit 140, a second generating unit 142, an image unit 150, a lighting calculating unit 160, and an interface unit 170.

The interface unit 170 shows the candidate of the object area 30 to the user, and receives a direction of the object area 30 to be displayed from the user. The interface unit 170 may also receive the viewpoint or the view direction from other software and so on. The candidate of the object area 30 may be registered with the holding unit (not shown) beforehand, or may be acquired from the data management apparatus 60. The data acquiring unit 110 requests transmission of information about the object area 30 specified by the user and so on to the data management apparatus 60, and acquires data like the modeling data, obtained by modeling a first area including at least a part of the object area 30, which represents the three-dimensional shape data of the first area, and the information for specifying the camera 40 shooting the object area 30 or the IPU50, from the data management apparatus 60. The first area is mainly composed by an object which does not change in a short term among the object area 30. The first generating unit 140 sets the viewpoint and the view direction specified by the user, and renders the modeling data, to generate the image of the first area.

The image acquiring unit 120 acquires a picture of a second area including at least a part of the object area 30 from the camera 40. The second area corresponds a shooting area of the camera 40. In a case where the object area 30 is shot by a plurality of cameras 40, the image acquiring unit 120 acquires the pictures from these cameras 40. The three-dimensional shape calculating unit 130 calculates a second shape data which represents a three-dimensional shape of the second area (also referred to as “real shape data” hereinafter) by using the picture acquired. The three-dimensional shape calculating unit 130 may generate the real shape data by generating depth information of every pixel from a plurality of the pictures shot by using stereo vision and so on. The second generating unit 142 sets the viewpoint and the view direction specified by the user, and renders the real shape data, to generate the image of the second area. The lighting calculating unit 160 acquires a situation of a lighting in the picture shot by comparing color information of the modeling data with color information of the real shape data. The information about the lighting may be used by the first generating unit 140 or the second generating unit 142 when rendering as described after. The image compositing unit 150 generates the image of the object area 30 by compositing the image of the first area and the image of the second area, and outputs the image of the object area 30 to the display apparatus 190.

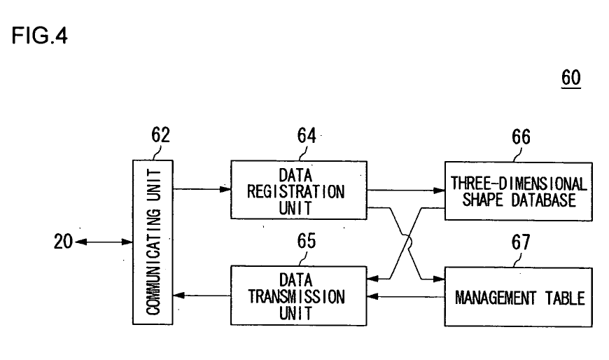

FIG. 4 shows an internal structure of the data management apparatus 60. The data management apparatus 60 mainly comprises a communicating unit 62, a data registration unit 64, a data transmission unit 65, a three-dimensional shape database 66, and a management table 67. The communicating unit 62 controls communication with an exterior through the Internet 20. The data registration unit 64 acquires the modeling data of the object area 30 from the exterior beforehand, and registers it into the three-dimensional shape database 66. The data registration unit 64 also acquires a data, such as a position and a direction of the camera 40, and time, through the Internet 20, and registers it into the management table 67. The three-dimensional shape database 66 stores the modeling data of the object area 30. The modeling data may be stored by a known data structure, for example, may be a polygon data, a wireframe model, a surface model, a solid model, etc. The three-dimensional shape database 66 may store a texture, the quality of the material, hardness, reflectance, etc. other than the form data of an object, and may hold information, such as a name of an object, and classification. The management table 67 stores the modeling data and data required for management of transmission and reception of the picture shot like position, direction, shooting time, or an identification information of the camera 40, an identification information of the IPU50, etc. The data transmission unit 65 transmits required data according to the data demand from the image generating apparatus 100.

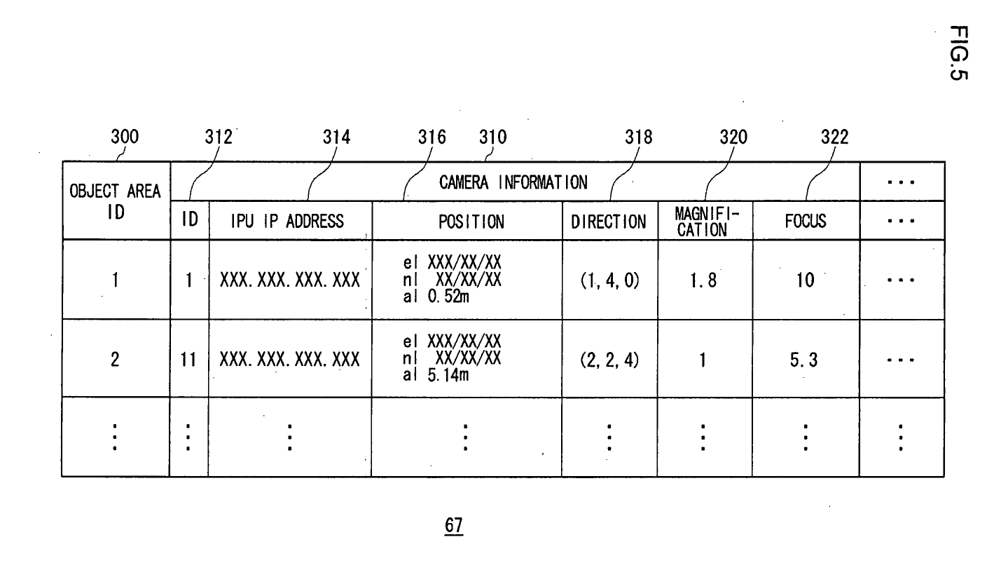

FIG. 5 shows an internal data of the management table 67. An object area ID column 300 which stores the ID for uniquely identifying the object area and a camera information column 310 which stores the information of the camera 40 located at the object area 30 are formed in the management table 67. The camera information column 310 is formed for each of the camera located at the object area 30. Each of the camera information columns 310 includes an ID column 312 which stores ID of the camera 40, an IP address column 314 which stores an IP address of the IPU50 connected to the camera 40, a position column 316 which stores a position of the camera 40, a direction column 318 which stores a shooting direction of the camera 40, a magnification column 320 which stores a magnification of the camera 40, and a focal length column 322 which stores a focal length of the camera 40. If the position, the shooting direction, the magnification, or the focal length of the camera 40 is changed, the change is notified to the data management apparatus 60, and the management table 67 is updated.

The detailed procedure of generating the image of the object area 30 by the modeling data and the real shape data are explained hereinafter.

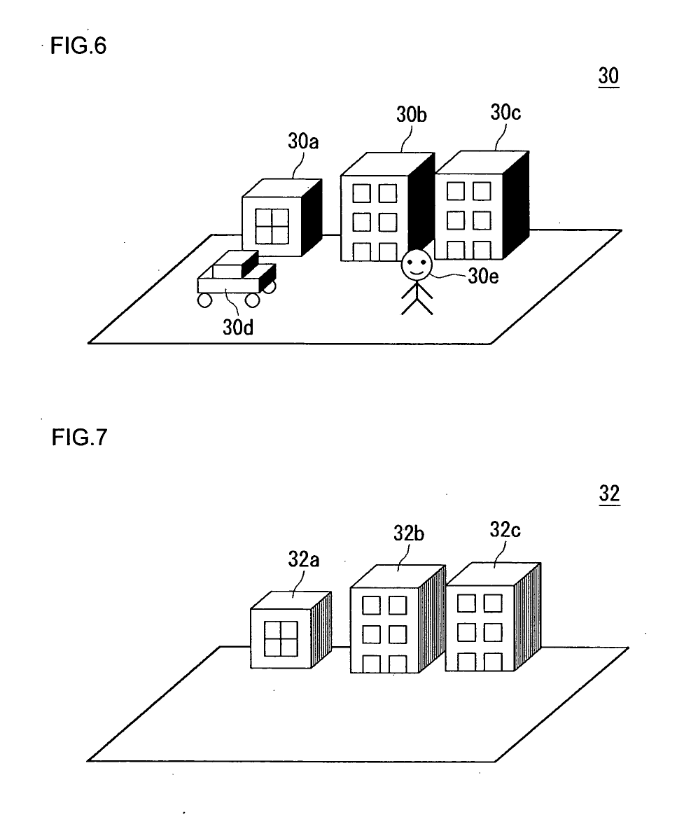

FIG. 6 shows an actual state of the object area 30. Buildings 30a, 30b, and 30c, a car 30d, and a man 30e exist in the object area 30. Among these, the buildings 30a, 30b, and 30c are objects which scarcely change in time, and the car 30d and the man 30e are objects which change in time.

FIG. 7 shows an image of a first area 32 generated by the modeling data registered into the data management apparatus 60. FIG. 7 shows the image generated by rendering the modeling data with setting a viewpoint to the upper part of the object area 30, and setting a view direction in the direction which overlooks the object area 30 from the viewpoint. In this example, the buildings 32a, 32b, and 32c which are the objects which do not change in a short term are registered into the data management apparatus 60 as the modeling data. The image generating apparatus 100 acquires the modeling data from the data management apparatus 60 by the data acquiring unit 110, renders the modeling data by the first generating unit 140, to generate the image of the first area 32.

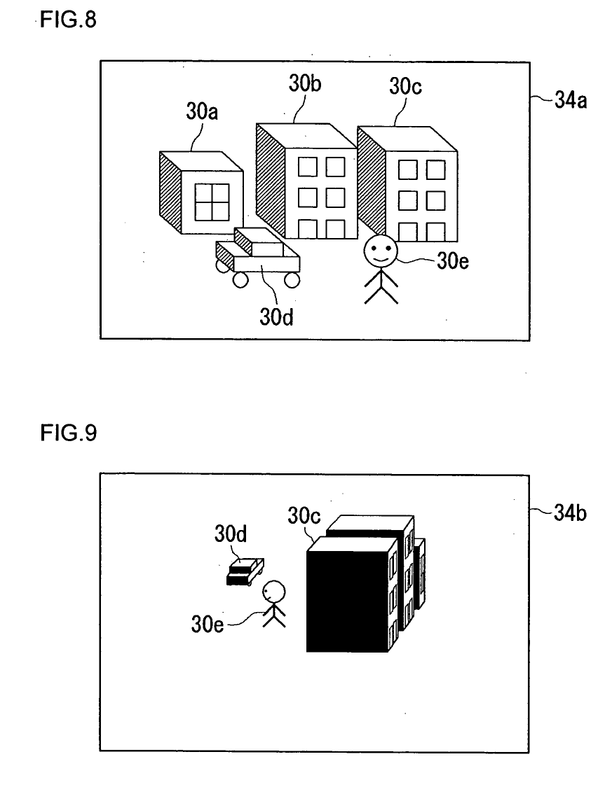

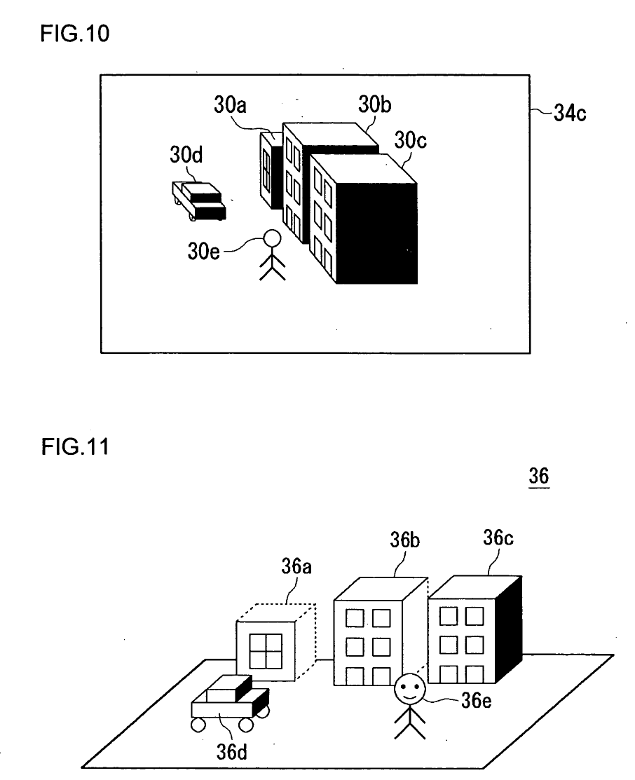

FIG. 8, FIG. 9, and FIG. 10 show the pictures 34a, 34b, and 34c of the second area shot by the camera 40. FIG. 11 shows an image of a second area 36 generated based on the real shape data calculated from the picture shot. FIG. 8, FIG. 9, and FIG. 10 show the pictures shot by three cameras 40. It is preferable that the object area 30 is shot by a plurality of the cameras 40 located at a plurality of positions to lessen the dead space which cannot be shot by the cameras 40 and to acquire the depth information of the object by using stereo vision and so on. In the case where the only one camera 40 shoots the object area 30, it is preferable that the camera 40 having a macrometer or a telemeter which can acquire the depth information is used. The image generating apparatus 100 acquires the pictures shot by the camera 40 with the picture acquiring unit 120, calculates the real shape data with the three-dimensional shape data calculating unit 130, and generates the image of the second area 36 with the second generating unit 142.

In FIG. 8, the buildings 30a, 30b, and 30c, the car 30d, and the man 30e are shot, but in FIG. 9 and FIG. 10, the side faces of the buildings 30a and 30d are hidden by the shadow of the building 30c, and only the part thereof is shot. If the three-dimensional shape data is calculated from these pictures by the stereo vision method and so on, the area which is not shot can not be match each other, therefore the real shape data can not be generated. In FIG. 11, a part of the side face and the upper face of the building 36a and a part of the side face of the building 36b are not shot, so that the whole buildings can not be reproduced. In the present embodiment, the image generated with the modeling data is composited on the image generated with the shot picture to reduce the blank area which can not be reproduced by the shot picture.

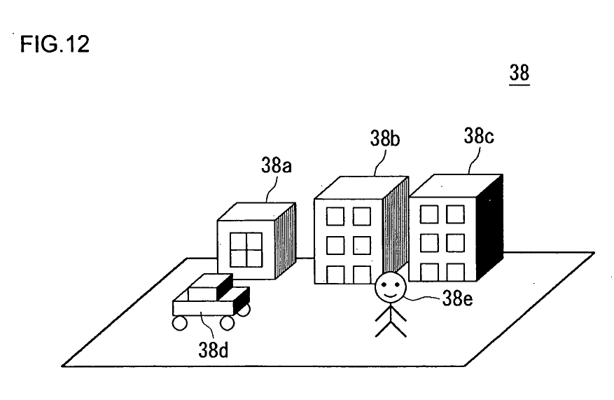

FIG. 12 shows an image generated by compositing the image of the first area shown in FIG. 7 and the image of the second area shown in FIG. 11. The image compositing unit 150 composites the image 32 of the first area generated by the first generating unit 140 based on the modeling data and the image 36 of the second area generated by the second generating unit 142 based on the real shape data to generate the image 38 of the object area 30. In the image 38, the side face and the upper face of the building 30a and the side face of the building 30b which can not be reproduced from the real shape data in the image 36, are complemented by the image based on the modeling data. Thus, at least an image of the area modeled previously can be generated by using the image based on the modeling data, a breakdown of a background can be reduced. Moreover, the present condition of the object area 30 can be reproduced correctly and finely by using the shot picture.

To composite the image of the first area and the image of the second area, the second generating unit 142 may draw the area where data is absent in a transparent color when generating the image of the second area, and the image compositing unit 150 may overwrite the image of the first area onto the image of the second area. To detect the area where data is absent caused by a shortage of information, a method can be used in which the result of the stereo vision with two or more combinations are compared and the area where the error exceeds the threshold is judged to be the area where data is absent. As to the area where the image is generated by the shot picture, the image itself can be used. As to the area where the data is absent in the shot picture, the image can be complemented by the image based on the modeling data. The image of the first area and the image of the second area may be mixed in a predetermined ratio. The image may be divided into objects by the shape recognition, the three-dimensional shape data may be calculated by the object, the shape data may be compared with the modeling data and may be composited by the object.

A technology such as a Z buffer algorithm can be used to remove the hidden surface, when compositing the image of the second area based on the shot picture with the image of the first area based on the modeling data. For example, the depth information z on each pixel of the image of the first area is stored to the buffer, and when overwriting the image of the second area at the image of the first area, if the depth of the pixel of the image of the second area is smaller than the depth information z stored at the buffer, it replaces by the pixel of the picture of the second area. Since it is expected that the depth information on the image of the second area generated from the shot picture has a certain amount of error, when comparing it with the depth information z held at the Z-buffer, this error may be taken into consideration. For example, a predetermined margin may be taken for the error. When performing hidden surface removal per object, correspondence of the same objects may be taken from the position relation between the object of modeling data and the object in the shot picture and the like, and the hidden surface removal may be performed with known algorithm.

The first generating unit 140 may acquire the viewpoint and the view direction of the camera 40 at the time when the object area 30 was shot, and may carry out the rendering of the modeling data using the viewpoint and the view direction acquired to generate the image of the first area. In this case, the picture acquired from the camera 40 itself may be used as the image of the second area. Thereby, an object registered into the modeling data can be added to or deleted from the picture shot by the camera 40. For example, by registering a building which will be built in the future as the modeling data, and compositing the image of the building with the picture shot, an anticipation image when a building is completed can be generated.

Moreover, a certain object in the picture shot can be deleted by judging to which pixel in the picture the object corresponds based on the modeling data of the object to delete and rewriting those pixels. The correspondence of the object may be judged with reference to a position, a color, etc. of the object. As for the area which constituted the eliminated object, it is preferable to be rewritten by the background image which must be seen when it assumes that the object do not exist. This background image may be generated by rendering the modeling data.

Next, the removal and addition of the lighting effect are explained. As mentioned above, when compositing the image based on the real shape data and the image based on the modeling data, since the real lighting is added on the image based on the real shape data but is not added to the image based on the modeling data, there is a possibility that the composited image may become unnatural. Moreover, there is a case where the virtual lighting is added to the composited image, such as, reproducing a situation in the evening using the picture shot at the morning. For such a use, it is explained how the effect of the lighting in an on-the-spot photo picture is computed, and how to cancel it or add the virtual lighting.

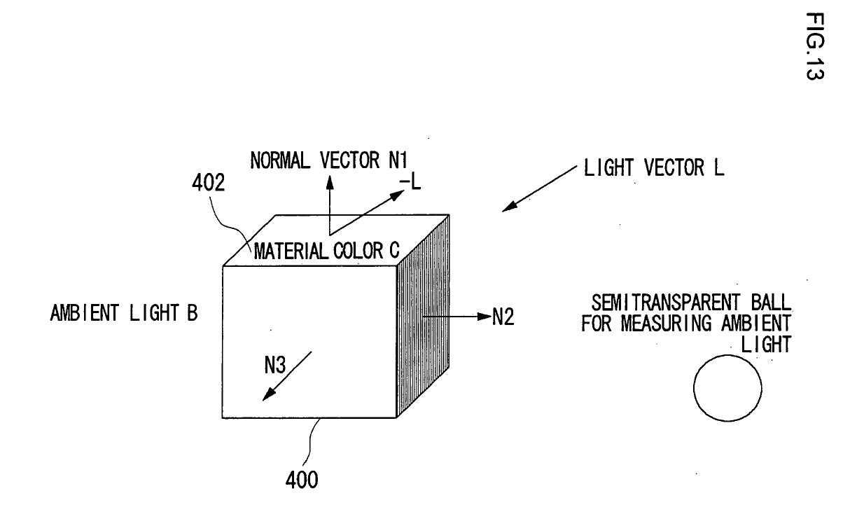

FIG. 13 is a Figure for explaining how computing a situation of lighting. Here, a parallel light source is assumed as a lighting model, and a full dispersion reflective model is assumed as a reflective model. In this case, a pixel value P=(R₁, G₁, B₁) in a plane 402 of an object 400 in the on-the-spot picture may be represented using a color data of a material C=(Sr₁, Sg₁, Sb₁), a normal vector N₁=(Nx₁, Ny₁, Nz₁), a light source vector L=(Lx, Ly, Lz), and environmental light data B=(Br, Bg, Bb) as follows:

R₁=Sr₁*(Limit(N₁·(−L))+Br)

G₁=Sg₁*(Limit(N₁·(−L))+Bg)

B₁=Sb₁*(Limit(N₁·(−L))+Bb)

where: Limit(X)=X for X≧0

Limit(X)=0 for X<0

If the light source vector L is a follow light to the camera then the Limit may be removed. In a case of a follow light, since the pixel value P becomes larger than the product of the color data of a material C and the environmental light data B, it is desirable to choose an object where R>Sr*Br, G>Sg*Bg, and B>SB*Bb. The color data C which is the pixel value of the pixel in the plane 402 of the object 400, and the normal vector N₁ which is the normalized normal vector of the plane 402 are acquired from the data management apparatus 60. In the case where the normal vector N₁ cannot be acquired from the data management apparatus 60 directly, the normal vector N₁ may be calculated by the shape data of the object 400. The environmental light data B may be measured by a half-transparent ball for example. The Br, Bg, Bb are coefficient whose value is from 0 to 1.

In order to calculate the light source vector L from the pixel value P of the shot picture using the above-mentioned formula, three equations for three planes whose normal vectors are linear independent should be solved. Three planes may be planes of the same object or planes of the different objects. It is preferable that the three planes are the planes in which the light source vector L is a follow light to the camera, as mentioned above. If the light source vector L is obtained by solving the equations, then the color data C of a material of the object which is not registered in the data management apparatus 60 among the objects shot in the picture, when the light is not added, can be calculated by formula as follows:

Sr=R/(N·L+Br)

Sg=R/(N·L+Bg)

Sb=R/(N·L+Bb)

Thereby, the effect of the lighting can be removed from the image of the second area based on the picture shot.

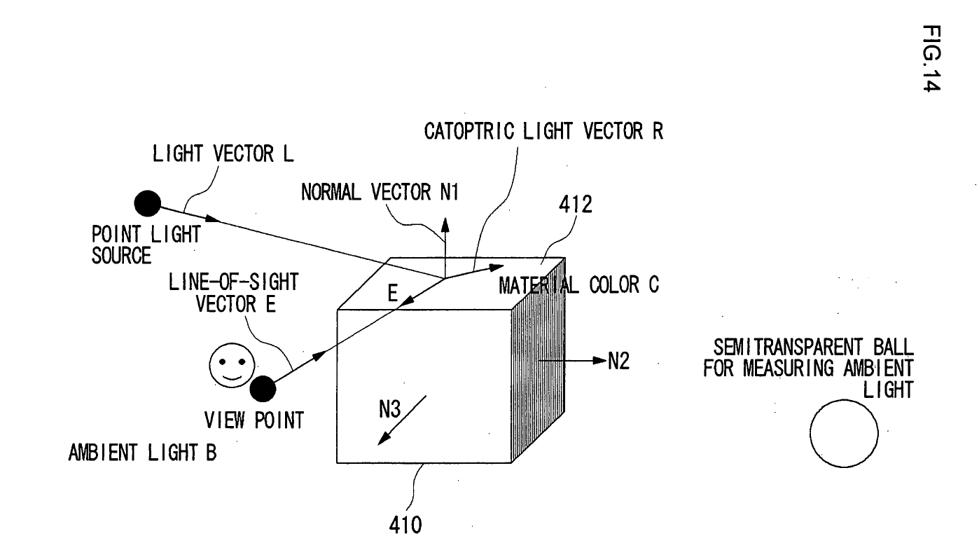

FIG. 14 is a Figure to illustrate another method for calculating the situation of the lighting. Here, a point light source is assumed as a lighting model, and a specular reflection model is assumed as a reflective model. In this case, a pixel value P=(R₁, G₁, B₁) in a plane 412 of an object 410 in the on-the-spot picture may be represented using a color data of a material C=(Sr₁, Sg₁, Sb₁), a normal vector N₁=(Nx₁, Ny₁, Nz₁), a light source vector L=(Lx, Ly, Lz), an environmental light data B=(Br, Bg, Bb), a view line vector E=(Ex, Ey, Ez), and a reflection light vector R=(Rx, Ry, Rz) as follows:

R₁=Sr₁*(Limit((−E)·R)+Br

G₁=Sg₁*(Limit((−E)·R)+Bg

B₁=Sb₁*(Limit((−E)·R)+Bb

where: (L+R)×N=0

|L|=|R|

Here, “x” represents outer product. Similar to the case of a parallel light source and a full dispersion reflective model, three equations are made using three pictures shot from three viewpoints. The reflection light vector R can be obtained by solving these three equations. Here, it is preferable that three equations are made for planes where R>Sr*BR, G>Sg*Bg, and B>Sb*Bb. Three view line vector must be linear independent.

The reflection light vector R is calculated, then the light source vector L can be calculated using (L+R)×N=0 and |L|=|R|. Specifically, L is calculated by the formula as follows:

L=2(N·R)N−R

The two light source vector L are calculated, then the position of the light source can be determined. The position of the light source and the light source vector L are calculated, then the effect of the lighting can be removed from the image of the second area based on the picture shot, similar to the example shown in FIG. 13.

Next, the foggy situation is assumed. The color data displayed is represented using the color data of the point of distance Z from the viewpoint (R, G, B), a Fog value f(Z), a Fog color (Fr, Fg, Fb) as follows:

R0=R*(1.0−f(Z))+Fr*f(Z)

G0=G*(1.0−f(Z))+Fg*f(Z)

B0=B*(1.0−f(Z))+Fb*f(Z)

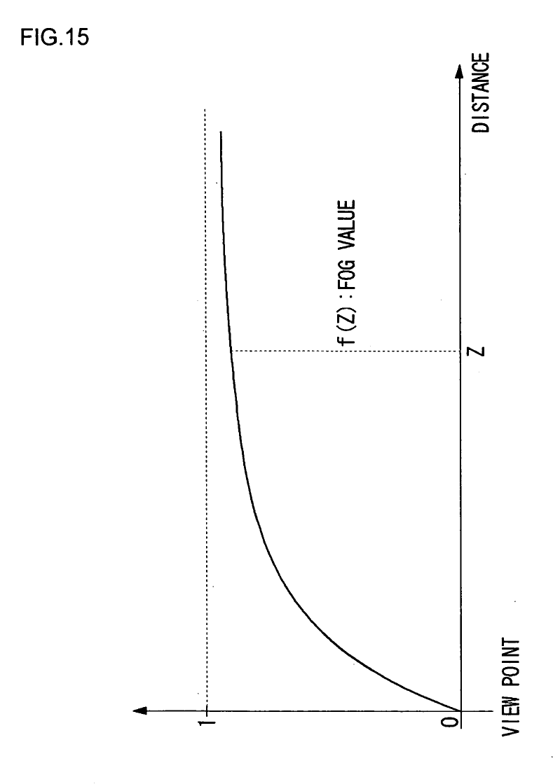

Here, f(Z) can be approximated by the following formula, as shown in FIG. 15 (See the Japanese Laid-Open patent document No. H07-021407).

(Z)=1−exp(−a*Z)

Here, “a” represents the density of the fog.

The object whose color data is known is positioned in front of the camera, and the picture of the object is shot by the camera, then the value a can be obtained by solving the equations for two points of the object. Specifically, two equations are:

R0=R*(1.0−f(Z0))+Fr*f(Z0)

R1=R*(1.0−f(Z1))+Fr*f(Z1)

The value a can be obtained by equation as follows:

(R0−R)(1−exp(−aZ1))=(R1−R)(1−exp(−aZ0))

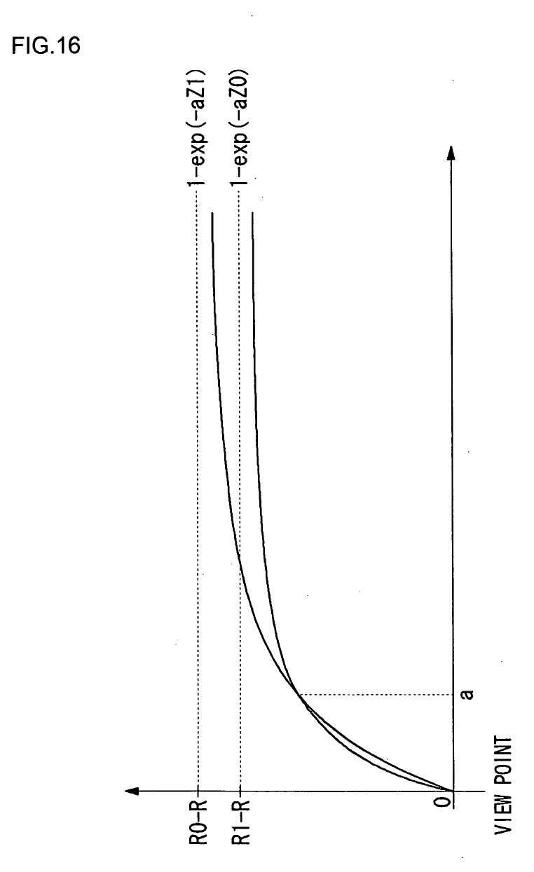

FIG. 16 shows how to obtain the value a which is intersection point of two exponential function of the left side and the right side of the equation.

As to the object with Fog in the on-the-spot picture, the color data without Fog can be calculated by above formula, by acquiring the position of the object from the data management apparatus 60, and calculating the distance Z from the camera 40.

Since the situation of the lighting in the shot picture using the on-the-spot picture and the modeling data, the effect of the lighting can be removed from the image of the second area based on the picture shot. Moreover, arbitrary effect of the lighting can be added to the image of the first area or the image of the second area when rendering, after removing the effect of the lighting from the image of the second area.

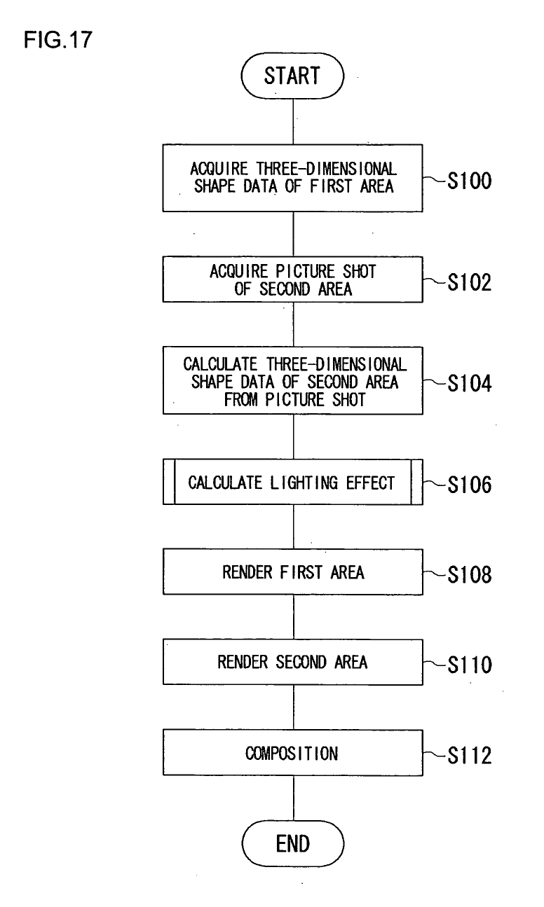

FIG. 17 is a flowchart showing the procedure of the image generating method according to the present embodiment. The image generating apparatus 100 acquires the three-dimensional shape data of the first area including at least one part of the object area 30 directed by the user from the data management apparatus 60 (S100). The image generating apparatus 100 further acquires the picture of the second area including at least one part of the object area 30 from the IPU 50 (S102). The three-dimensional shape calculating unit 130 calculates the real shape data (S104). The lighting calculating unit 160 calculates the situation of the lighting in the shot picture (S106), if necessary. The first generating unit 140 generates the image of the first area by rending the modeling data (S108). The second generating unit 142 generates the image of the second area by rendering the real shape data (S110). At this time, the lighting effect may be removed or predetermined lighting may be added in consideration of the lighting effect calculated by the lighting calculating unit 160. The image compositing unit 150 generates the image of the object area 30 by compositing the image of the first area and the image of the second area (S112).

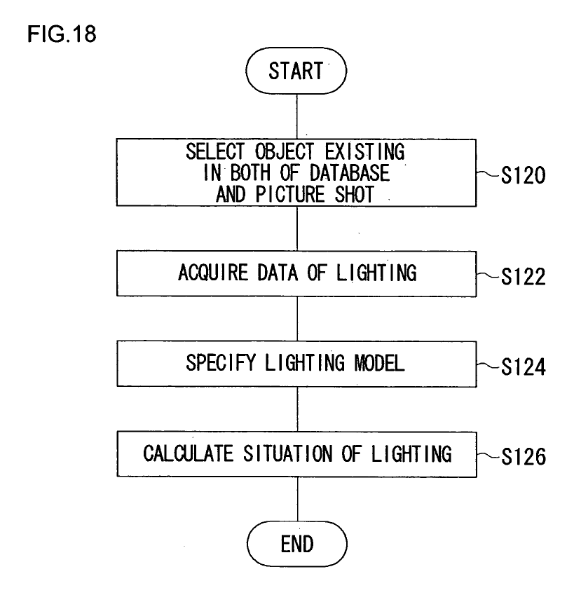

FIG. 18 is a flowchart showing the procedure of the lighting calculating method according to the present embodiment. The lighting calculating unit 160 selects the object which is registered in the data management apparatus 60 and is shot in the on-the-spot picture to calculate the situation of the lighting in the on-the-spot picture (S120). The lighting calculating unit 160 acquires the data about the lighting such as the color information or the position information of the object (S122). The lighting calculating unit 160 specify the appropriate lighting model for calculating the situation of the object area 30 (S124). The lighting calculating unit 160 calculates the situation of the lighting according to the lighting model (S126).

(Second Embodiment)

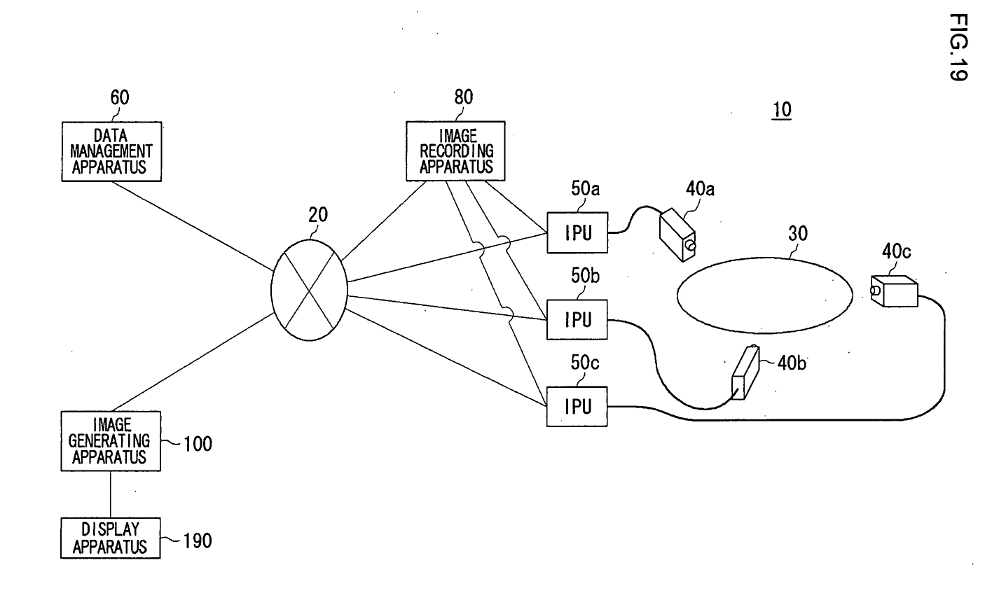

FIG. 19 shows a structure of an image generating system according to a second embodiment of the present invention. The image generating system 10 according to the present embodiment further comprises an image recording apparatus 80 connected to the IPU 50a, 50b, and 50c and the Internet 20, in addition to the structure of the image generating system 10 according to the first embodiment shown in FIG. 1. The image recording apparatus 80 acquires the on-the-spot picture of the object area 30 shot by the camera 40 from the IPU 50, and records them serially. The image recording apparatus 80 sends the picture shot at the time specified by the image generating apparatus 100 to the image generating apparatus 100. The three-dimensional shape database 66 of the data management apparatus 60 stores the modeling data of the object area 30 corresponding to the predetermined term from the past to present. The three-dimensional shape database 66 sends the modeling data of the time specified by the image generating apparatus 100 to the image generating apparatus 100. Thereby, the image generating apparatus 100 can reproduce the situation of the past object area 30. The different point from the first embodiment is mainly explained hereinafter.

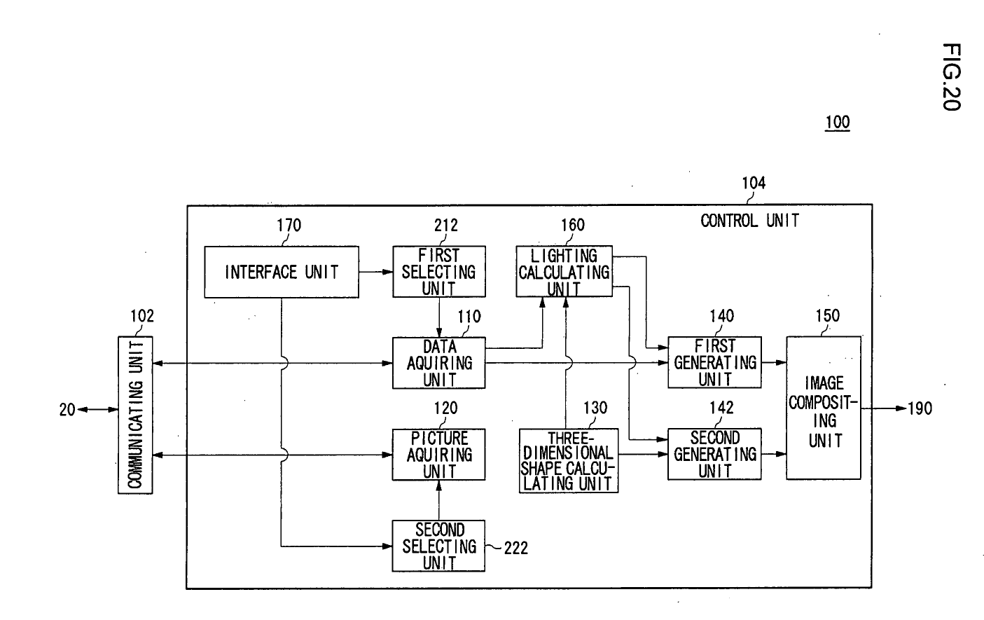

FIG. 20 shows an internal structure of the image generating apparatus 100 according to the present embodiment. The image generating apparatus 100 of the present embodiment further comprises a first selecting unit 212 and a second selecting unit 214, in addition to the structure of the image generating apparatus 100 according to the first embodiment shown in FIG. 3. Other structure is similar to the first embodiment. The structure of the data management apparatus 60 of the present embodiment is similar to the structure of the data management apparatus 60 of the first embodiment shown in FIG. 4.

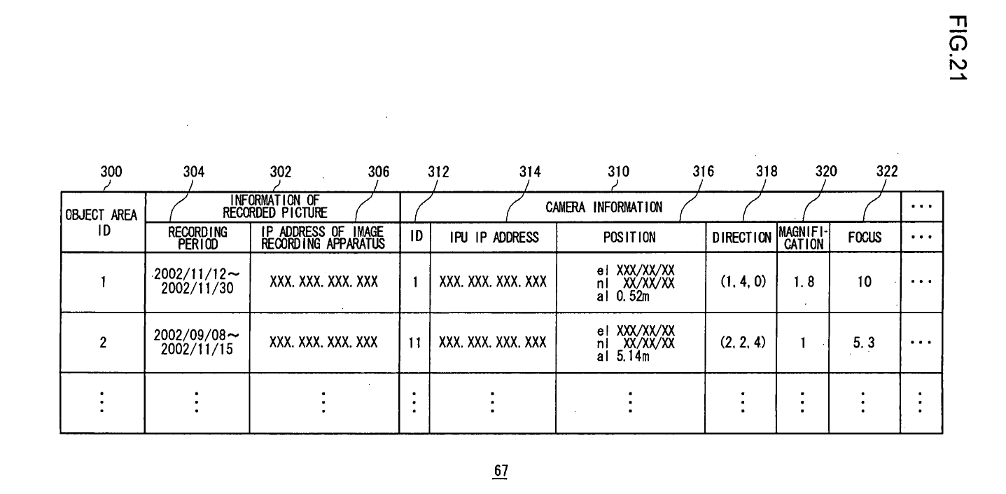

FIG. 21 shows an internal data of the management table 67 according to the present embodiment. The management table 67 of the present embodiment further includes an information of recorded picture column 302, in addition to the internal data of the management table 67 according to the first embodiment shown in FIG. 6. The information of recorded picture column 302 has a recording period column 304 which stores the recording period of the pictures recorded in the image recording apparatus 80, and an IP address of image recording apparatus column 306 which stores an IP address of the image recording apparatus 80.

When the user selects the object area 30 and time of the image to be generated via the interface unit 170, if the time specified is the past, then the first selecting unit 212 selects the modeling data to be acquired by the data acquiring unit 110 among a plurality of the modeling data of the object area 30 stored in the data management apparatus 60, and directs the data acquiring unit 110. The second selecting unit 222 selects the picture to be acquired by the picture acquiring unit 120 among a plurality of the pictures stored in the image recording apparatus 80, and directs the picture acquiring unit 120. The first selecting unit 212 may select the modeling data corresponding to the time of the picture selected by the second selecting unit 222. Thereby, the image of the past object area 30 can be reproduced. The procedure of generating the image of the object area 30 using the modeling data and the on-the-spot picture is similar to the first embodiment.

The time of the modeling data selected by the first selecting unit 212 and the time of the picture selected by the second selecting unit 222 are not necessarily the same. For example, the past modeling data and the present picture may be composited. The image merged the different time of the situation of the object area 30 may be generated by compositing the image of the past object area 30 reproduced by the past modeling data and the image of the passenger extracted from the present picture. The object may be extracted from the picture by a technology like shape recognition. The picture and the modeling data corresponding to the shooting time of the picture may be compared and the difference may be calculated so that the object existing in the picture and not existing in the modeling data can be extracted.

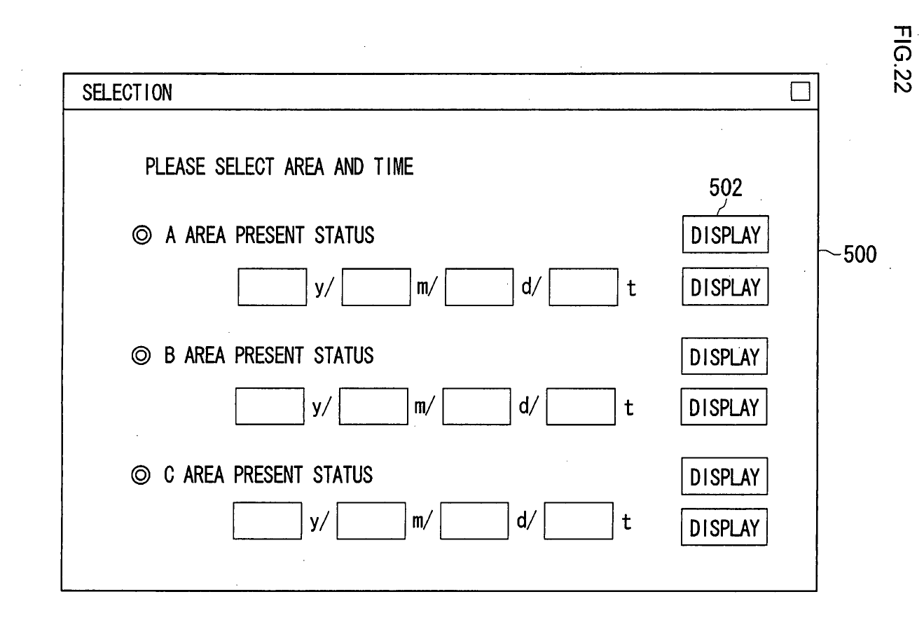

FIG. 22 shows an example of the selecting screen showed by the interface unit 170 of the image generating apparatus 100. The selecting screen 500 shows the candidate of the object area 30, “A area”, “B area”, and “C area”, and the user can select whether the present status or the past status is displayed. If the user selects the object area and the time, and clicks the display button 502, then the interface unit 170 notices the selected object area and the time to the first selecting unit 212 and the second selecting unit 222. The management table 67 may store the information about the object area 30 such as the information of “sports institution” and “shopping quarter”, and the user may select the object area based on these keywords. The object area may be selected by specifying the viewpoint and the view direction, and the camera 40 shooting the specified area may be searched in the management table 40. If the modeling data of the area specified by the user exists but the camera 40 shooting the area does not exist, then the image based on the modeling data may be showed to the user. If the modeling data of the area specified by the user does not exist but the camera 40 shooting the area exists, then the image based on the picture shot may be showed to the user.

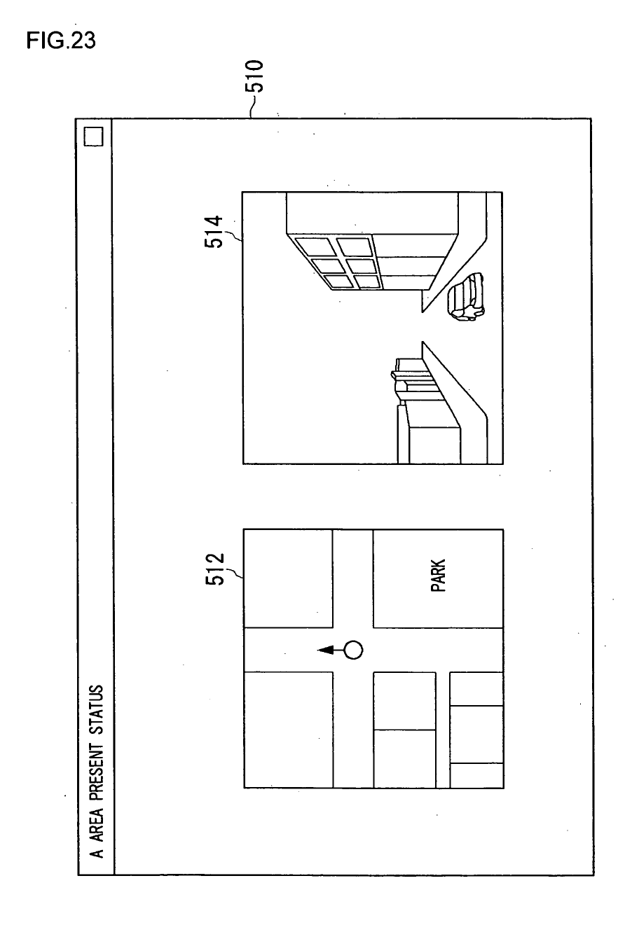

FIG. 23 shows a screen 510 showing the image of the object area 30 generated by the image generating apparatus 100. The map 512 of the object area 30 is showed in the left side of the screen 510, and the present viewpoint and the view direction are also showed. The image of the object area 30 is showed in the right side of the screen 510. The user can change the viewpoint and the view direction via the interface unit 170 and the like. The first generating unit 140 and the second generating unit 142 generates the image with setting the viewpoint and the view direction specified by the user. The information about the object such as the name of the building may be registered in the data management apparatus 60, and the information may be displayed when the user clicks the object.

The present invention has been described based on the embodiments which are only exemplary. It is understood by those skilled in the art that there exist other various modifications to the combination of each component and process described above and that such modifications are encompassed by the scope of the present invention.

The image generating apparatus 100 displays the generated image to the display apparatus 190 in the embodiments, but the image generating apparatus 100 may send the generated image to a user terminal and the like via the Internet. The image generating apparatus 100 may have a function of a server.

Although the present invention has been described by way of exemplary embodiments, it should be understood that many changes and substitutions may further be made by those skilled in the art without departing from the scope of the present invention which is defined by the appended claims.

What is claimed is:

1. An image generating system, comprising:
a database which stores first shape data which represents a three dimensional shape of a first area including at least a part of an object area;
a camera which shoots a second area including at least a part of the object area; and
an image generating apparatus which generates an image of the object area using a picture shot by the camera and the first shape data, wherein said image generating apparatus includes:
a data acquiring unit which acquires the first shape data from said database;
a picture acquiring unit which acquires the picture from said camera;
a first generating unit which generates an image of the first area by setting a predetermined viewpoint and a view direction and rendering the first shape data;
a second generating unit which generates an image of the second area when viewed from the viewpoint toward the view direction by using the picture; and
a compositing unit which composites the image of the first area with the image of the second area to generate the image of the object area.

2. An image generating system according to claim 1, wherein:
said image generating system includes a plurality of cameras located at a plurality of positions;
said image generating apparatus further comprises a calculating unit which calculates second shape data which represents a three dimensional shape of the second area using a plurality of the pictures acquired from said plurality of cameras;
said second generating unit sets the viewpoint and the view direction and renders the second shape data to generate the image of the second area.

3. An image generating system according to claim 2 wherein said compositing unit generates the image of the object area by complementing an area that is not represented by the second shape data with the image of the first area generated from the first shape data.

4. An image generating system according to claim 2, wherein:
said second generating unit renders the area which is not represented by the second shape data with a transparent color when rendering the second shape data;
said compositing unit generates the image of the object area by overwriting the image of the second area with the image of the first area.

5. An image generating system according to claim 1 wherein said database stores the first shape data obtained by modeling an area which does not change in a short term in the object area.

6. An image generating system according to claim 2 wherein said database stores the first shape data obtained by modeling an area which does not change in a short term in the object area.

7. An image generating system according to claim 3 wherein said database stores the first shape data obtained by modeling an area which does not change in a short term in the object area.

8. An image generating system according to claim 4 wherein said database stores the first shape data obtained by modeling an area which does not change in a short term in the object area.

9. An image generating system according to claim 1, wherein:
said database stores first color data which represents a color of the first area;
said image generating apparatus further includes a lighting calculating unit which calculates a situation of a lighting in the picture shot by comparing the first color data acquired from said database with color data of the picture shot.

10. An image generating system according to claim 2, wherein:
said database stores first color data which represents a color of the first area;
said image generating apparatus further includes a lighting calculating unit which calculates a situation of a lighting in the picture shot by comparing the first color data acquired from said database with color data of the picture shot.

11. An image generating system according to claim 3, wherein:
said database stores first color data which represents a color of the first area;
said image generating apparatus further includes a lighting calculating unit which calculates a situation of a lighting in the picture shot by comparing the first color data acquired from said database with color data of the picture shot.

12. An image generating system according to claim 4, wherein:
said database stores first color data which represents a color of the first area;
said image generating apparatus further includes a lighting calculating unit which calculates a situation of a lighting in the picture shot by comparing the first color data acquired from said database with color data of the picture shot.

13. An image generating system according to claim 5, wherein:
said database stores first color data which represents a color of the first area;
said image generating apparatus further includes a lighting calculating unit which calculates a situation of a lighting in the picture shot by comparing the first color data acquired from said database with color data of the picture shot.

14. An image generating system according to claim 9 wherein said first generating unit adds an effect of lighting similar to the lighting in the picture shot to the image of the first area in consideration of the situation of the lighting.

15. An image generating system according to claim 9, wherein:
said first generating unit adds a predetermined effect of lighting to the image of the first area;
said second generating unit adds the predetermined effect of lighting to the image of the second area, after once removing the effect of lighting from the image of the second area.

16. An image generating system according to claim 1, wherein:
said image generating system further comprises a recording apparatus which stores the picture shot,
said database stores a plurality of the first shape data corresponding to the object areas of a plurality of times;
said image generating apparatus further includes:
a first selecting unit which selects the first shape data to be acquired by the data acquiring unit among the plurality of the first shape data stored in said database;
a second selecting unit which selects the picture shot to be acquired by the picture acquiring unit among the pictures stored in said recording apparatus.

17. an image generating system according to claim 16 wherein said second selecting unit selects the first shape data corresponding to the time when the picture selected by said first selecting unit was shot.

18. An image generating apparatus, comprising:
a data acquiring unit which acquires first shape data which represents a three dimensional shape of a first area including at least one part of an object area from a database which stores the first shape data;
a picture acquiring unit which acquires a picture of a second area including at least one part of the object area shot by a plurality of cameras located at a plurality of positions from the cameras;
a first generating unit which generates an image of the first area by setting a predetermined viewpoint and a view direction and rendering the first shape data;
a second generating unit which generates an image of the second area when viewed from the viewpoint toward the view direction by using the picture shot; and
a compositing unit which composites the image of the first area with the image of the second area to generate the image of the object area.

19. An image generating method, comprising:
acquiring first shape data which represents a three dimensional shape of a first area including at least one part of an object area from a database which stores the first shape data;
acquiring a picture of a second area including at least one part of the object area shot from a plurality of positions;
generating an image of the first area by setting a predetermined viewpoint and a view direction and rendering the first shape data;
generating an image of the second area when viewed from the viewpoint toward the view direction by using the picture shot; and
compositing the image of the first area with the image of the second area to generate the image of the object area.

20. An image generating method, wherein when generating an image of an object area viewed from a predetermined viewpoint toward a predetermined view direction using a plurality of pictures shot by a plurality of cameras and acquired from the cameras in real time, the method generating the image of the object area which represents a present state of the object area artificially by complementing the pictures with an image generated by using three-dimensional shape data obtained by modeling at least a part of the object area.

21. A program executable by a computer, the program including the functions of:
acquiring first shape data which represents a three dimensional shape of a first area including at least one part of an object area from a database which stores the first shape data;
acquiring a picture of a second area including at least one part of the object area shot from a plurality of positions;
generating an image of the first area by setting a predetermined viewpoint and a view direction and rendering the first shape data;
generating an image of the second area when seeing from the viewpoint toward the view direction by using the picture shot; and
compositing the image of the first area with the image of the second area to generate the image of the object area.

22. A computer-readable recording medium which stores a program executable by a computer, the program including the functions of:
acquiring first shape data which represents a three dimensional shape of a first area including at least one part of an object area from a database which stores the first shape data;
acquiring a picture of a second area including at least one part of the object area shot from a plurality of positions;
generating an image of the first area by setting a predetermined viewpoint and a view direction and rendering the first shape data;
generating an image of the second area when seeing from the viewpoint toward the view direction by using the picture shot; and
compositing the image of the first area with the image of the second area to generate the image of the object area.
